(19) United States
(12) Patent Application Publication
(10) Pub. No.: US 2025/0124633 A1
(43) Pub. Date: Apr. 17, 2025

(54) VIRTUAL AVATAR ANIMATION

(71) Applicant: SOUL MACHINES LIMITED, Auckland (NZ)

(72) Inventors: Mark Sagar, Auckland (NZ); Tim WU, Auckland (NZ); Tiago Ribeiro, Lisboa (PT); Pavel Sumetc, Auckland (NZ)

(21) Appl. No.: 18/702,866

(22) PCT Filed: Oct. 20, 2022
(86) PCT No.: PCT/IB2022/060073

§ 371 Date: Apr. 19, 2024

(30) Foreign Application Priority Data
Oct. 22, 2021 (NZ) 781589

(51) Int. Cl. G06T 13/40; G06N 20/20

(52) U.S. Cl. CPC G06T 13/40; G06N 20/20

(57) ABSTRACT

Described is a method for controlling motion of a digital character, comprising: receiving one or more behaviour commands; translating the one or more behaviour commands into a time-sequence of channel parameters for one or more animation channels; receiving one or more motion sources; determining one or more motion parameters by applying the channel parameters to corresponding blend nodes in a blend tree based on the motion sources; and controlling motion of the digital character based on the one or more motion parameters. Also described is a system implementing the method.

### TECHNICAL FIELD

Embodiments of the invention relate to computer graphics character animation. More particularly but not exclusively, embodiments of the invention relate to virtual avatar animation.

### BACKGROUND ART

Smartbody¹, EMBR², Greta³ and AsapRealizer⁴ are frameworks for interactive expressive embodied conversation agents that can be used to deliver interactive digital humans. They are particularly focused on behaviour performance, and are all based on blocks of an XML-style scripting language called BML which specifies particular expressive modalities through time, such as gestures of the arms or of the head.

These multimodal expression blocks in Smartbody¹, EMBR², Greta³ and AsapRealizer⁴ are driven by rule-based behaviour planners that attempt to solve conflicts and priorities using explicit rules about expressive behaviour performance. The performance of these multimodal expressions in EMBR², Greta³ and AsapRealizer⁴ is generated by a Realizer which contains logic for loading and generating motion data for specific modalities, along with modality-specific rules for dealing with synchronization and conflicts. In Smartbody¹ the performance is generated by a Motion Control Engine which contains a composition of motion controllers organized in a prioritized layering of concurrent sequences of motion operations with overlapping transitions. Smartbody¹, EMBR² and Greta³ rely on a fixed motion plan that is fully precomputed from a given BML block and therefore does not allow for on-the-fly adaptation and graceful interruption of the virtual avatar's expressive motion.

Our invention allows to drive the animation of a virtual avatar from a high-level symbolic and hierarchical behaviour command without being tied to particular modalities or rules. It provides an abstract animation planning and mixing logic that allows the final animation composition to be specified using a system that is more familiar to animation artists such as a blend tree. It is not tied to a rigid behaviour plan or expressive modalities, so the avatar's performance can both be modified or interrupted in real-time. Artists can design behaviours holistically (full-body, not modality-specific) and other holistic methods of behaviour generation (such as but not limited to motion capture) can be used and blended into the avatar's performance.

¹ Thiebaux, Marcus & Marsella, Stacy & Marshall, Andrew & Kallmann, Marcelo. (2008). SmartBody: Behavior realization for embodied conversational agents. DOI 10.1145/1402383.1402409.

² Heloir, Alexis & Kipp, Michael. (2009). EMBR-A Realtime Animation Engine for Interactive Embodied Agents. DOI 10.1109/ACII.2009.5349524.

³ Niewiadomski, Radoslaw & Bevacqua, Elisabetta & Mancini, Maurizio & Pelachaud, Catherine. (2009). Greta: An interactive expressive ECA system. DOI 10.1145/1558109.1558314.

⁴ Welbergen, Herwin & Yaghoubzadeh Torky, Ramin & Kopp, Stefan. (2014). AsapRealizer 2.0: The Next Steps in Fluent Behavior Realization for ECAs. DOI 10.1007/978-3-319-09767-1_56.

In EP3871194, there is disclosed a method for creating a model of a virtual character. The model is formed from a plurality of basic shapes, e.g. shapes representing different body parts such as a body or a face. Modifications are made to the basic shape, which may be demographic prediction modifications including ageing, gender, ethnicity, and physique. Movements of the virtual character, e.g. changes in facial expression, can be synthesized by controlling regions on a shape through muscle deformation descriptors. The prior document, however, fails to teach a robust framework for controlling motion of the virtual character.

US20100302257 describes a method for blending animations. A live motion of a user may be captured and a pre-recorded motion such as a pre-recorded artist generated motion, a pre-recorded motion of the user, and/or a programmatically controlled transformation may be received. The live motion may then be applied to a first portion of a virtual character and the pre-recorded motion may be applied to a second portion of the virtual character such that the virtual character may be animated with a combination of the live and pre-recorded motions.

### OBJECT OF INVENTION

It is an object of the invention to improve virtual avatar animation, or to at least provide the public or industry with a useful choice.

### SUMMARY OF INVENTION

In a first example embodiment there is provided a method for controlling motion of a digital character, comprising:
i. receiving one or more behaviour commands;
ii. translating the one or more behaviour commands into a time sequence of channel parameters for one or more animation channels;
iii. receiving one or more motion sources;
iv. determining one or more motion parameters by applying the time sequence of channel parameters to corresponding blend nodes in a blend tree based on the motion sources; and
v. controlling motion of the digital character based on the one or more motion parameters

In an example, the one or more behaviour commands describe and specify behaviour actions along with supplementary motion and composition configurations.

In an example, the one or more behaviour commands comprise behaviour metadata and a command descriptor.

In an example, receiving motion sources comprises receiving a pose of the digital character that is interpolated or extrapolated in the time-domain.

In an example, receiving motion sources comprises receiving a pose of the digital character that is neither interpolated or extrapolated.

In an example, the motion sources comprise a high priority motion source and a low priority motion source, wherein the high priority motion source superimposes over a low priority motion source in determining one or more motion parameters.

In an example, the motion sources comprise a plurality of motion sources, each motion source having a priority, wherein the plurality of motion sources are ordered by their priority and a high priority motion source superimposes over a low priority motion source in determining one or more motion parameters.

In an example, the time sequence of channel parameters is based on incremental time steps.

In an example, the time sequence of channel parameters is configured to cause changes to channel states in an animation planner.

In an example, further comprising computing an output of the blend tree.

In an example, computing the output of the blend tree follows an algorithm for traversing tree or graph data structures.

In an example, computing the output of the blend tree follows a method that produces a similar result as a depth-first search.

The method of any one of claims 1 to 12, wherein the blend tree comprises a single root blend node, a plurality of blend nodes adjacent to the root blend node or to the plurality of blend nodes, and a plurality of source nodes adjacent to the plurality of blend nodes.

In an example, determining one or more motion parameters comprises performing space-warping.

In an example, determining one or more motion parameters comprises performing time-warping.

In a second example embodiment there is provided a non-transitory computer-readable medium comprising instructions which, when executed by a computer, cause the computer to perform the method of the first example embodiment.

In a third example embodiment there is provided a system for controlling motion of a digital character according to the method of the first example embodiment, comprising:
i. a behaviour command system for selecting and providing behaviour commands;
ii. an animation framework for receiving and processing behaviour commands and motion sources;
iii. animation channels configurable based on channel parameters;
iv. a controller for controlling motion of the digital character based on motion parameters; and
v. a presentation system for presenting the controlled motion of the digital character.

In an example, the animation framework comprises an animation planning system comprising multi-channel state machines and a clock, wherein states of the multi-channel state machines are configured to be reevaluated and may change at a time-step generated by a clock.

In an example, further comprising a conductor system configured for determining a target state based on behaviour commands and for adjusting an animation channel of the multi-channel state machines based on the target state.

In an example, the animation framework comprises an animation mixing system, the animation mixing system being configured to apply channel parameters to corresponding blend nodes of a blend tree.

### BRIEF DESCRIPTION OF DRAWINGS

FIG. 1 shows a system overview of the Framework for Virtual Avatar Animation and

FIG. 2 shows the Embodiment system and;

FIG. 3 shows a Behaviour Command system and

FIG. 4 shows a Motion Source system and

FIG. 5 shows an Animation Planning system and

FIG. 6 shows a Conductor system and

FIG. 7 shows an Animation Mixing system and

FIG. 8 shows an example Blend Tree.

### DISCLOSURE OF INVENTION

Embodiments of the invention relate to Virtual Avatar Animation. Embodiments of the invention relate to a Framework for Virtual Avatar Animation, Behaviour Commands, Motion Sources, Motion Parameters, Animation Planning and Animation Mixing.

The Framework addresses the problem of controlling the motion of a digital character based on asynchronous input sequences of Behaviour Commands and by computing a set of output Motion Parameters based on the composition of multiple Motion Sources.

The composition of Motion Sources may consider that at some instance, some Motion Sources may have a higher priority and should superimpose over lower priority Motion Sources.

The composition of Motion Sources may consider that at any instance, space-warping and time-warping may be applied to some of the Motion Sources.

At any moment, a Behaviour Command may be provided to the system which may result in changes to the state of the system that relate to the playback of motion sources and to the composition of motion sources and to the output Motion Parameters of the framework.

The output Motion Parameters of the framework is the result of the composition of Motion Sources as specified in the previous paragraphs.

### Framework for Virtual Avatar Animation

The Framework for Virtual Avatar Animation 100 addresses the problem of controlling the motion of digital characters through a series of steps and components that compose the pipeline of the Framework 100. Each of the steps has a particular function and contribution to the overall motion.

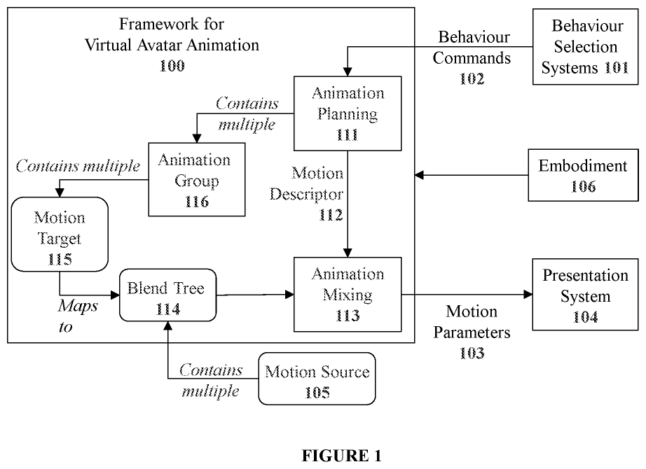

FIG. 1 shows a schematic representation of the Framework 100 system. The Framework 100 may operate between Behaviour Selection 101 systems which may be driven by artificial intelligence techniques or rule-based systems, or user inputs, or by a composition of those; and a Presentation System 104 that may present the resulting motion through a visual or physical form to the end-user.

The Framework 100 may contain a representation of the character in the form of an Embodiment 106. An Embodiment 106 may contain visual or physical 110 and kinematic information required for the computation, and representation of the character in the Presentation System 104.

The input of the Framework 100 may be a set of Behaviour Commands 102.

The output of the Framework 100 may be a set of Motion Parameters 103 such as but not limited to rotation representations, translation representations, transformation representations, deformation representations or Action Unit Descriptors, as described in NZ Provisional Patent App. NZ770157 Skeletal Animation In Embodied Agents.

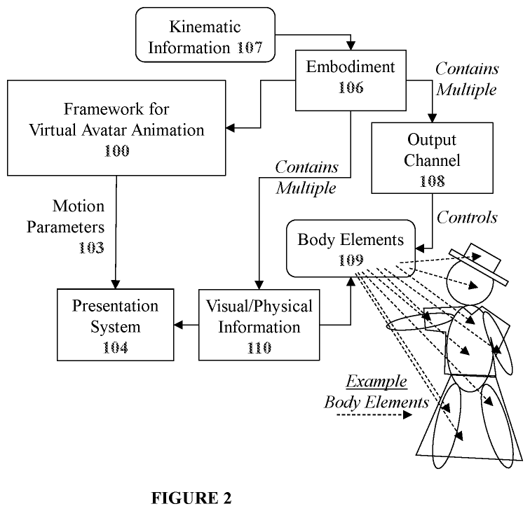

FIG. 2 shows the Embodiment 106 may be composed of Body Elements 109, each of which may be controlled by a specific Output Channel 108. Each Output Channel 108 may translate and render a given Motion Parameter 103 as a change of the visual or physical state of the corresponding element based on its corresponding Kinematic Information 107.

The Framework 100 may be configured from a set of Motion Sources 105 and from a Blend Tree.

### Behaviour Command

A Behaviour Command 102 describes and specifies behaviour actions along with supplementary motion and composition configurations. For example, a Behaviour Command 102 may be provided from a system such as that described in NZ Provisional Patent 770193 Autonomous Animation In Embodied Agents, which discloses a system for automatically injecting Behaviour Commands into avatar conversation based on semantic information.

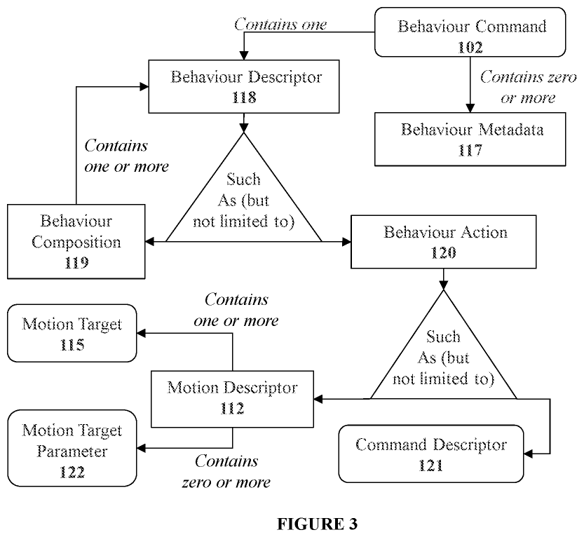

FIG. 3 shows a schematic representation of the Behaviour Command 102 system. A Behaviour Command 102 may contain Behaviour Metadata 117 and may contain a Behaviour Descriptor 118. A Behaviour Descriptor 118 may describe a composition or specification of behaviour, such as but not limited to, a Behaviour Action 120 or a Behaviour Composition 119 of Behaviour Descriptors 118. A Behaviour Action 120 may contain a specification of behaviour, such as but not limited to a Motion Descriptor 112 or a Command Descriptor 121. A Command Descriptor 121 may contain a description and parameters of operations that cause a change to any of the Framework's parameters. A Motion Descriptor 112 may contain a set of Motion Targets 115 and a set of Motion Target Parameters 122, each of which may correspond to one of the Motion Targets 115. A Motion Target 115 may refer to an element of the Framework 100 that can be commanded by Behaviour Actions 120 such as, but not limited to, a Motion Source 105, a Motion Channel 124 or a Blend Node 141. A Motion Target Parameter 122 may be any type of value or structure of values required to control a single element of the Framework 100.

### Motion Source

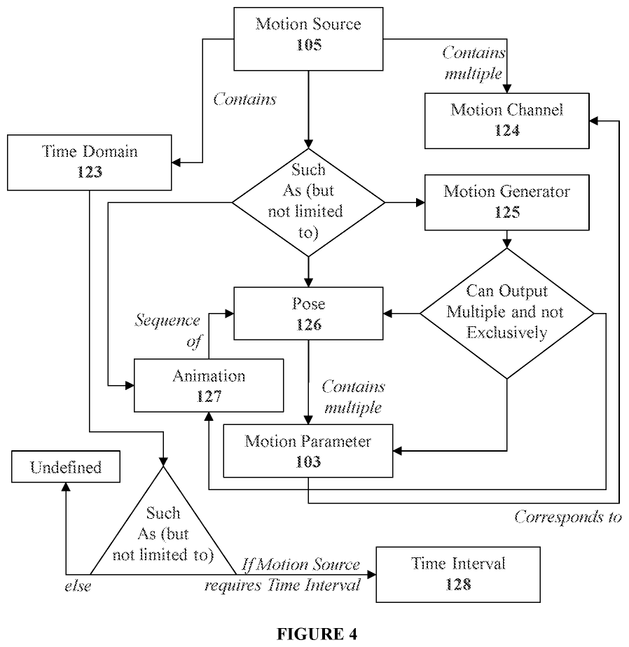

FIG. 4 shows a schematic representation of the Motion Source 105 system. A Motion Source 105 may have a Time Domain 123 definition, which may correspond to a Time Interval 128, and multiple Motion Channels 124, where each Motion Channel 124 may correspond to an Output Channel 108 of the Embodiment 106.

A Motion Source 105 represents a multidimensional function M (i, t): Z, R→A where codomain A is a space of Motion Parameter 103 elements. The function M maps the Motion Channel 124 i at a given time t to a representation of A. The domain of the coordinate t of the function M may be referred to as the time-domain.

A Motion Source 105 may be a Pose 126 or may be a sequence of Poses 126 or may be a Motion Generator 125 or any other source of motion data.

A Pose 126 may contain a set of Motion Parameters 103 which may correspond to each Motion Channel 124 of the Motion Source 105. The Motion Parameters 103 of a Pose 126 may be pre-defined, or computed during execution.

A sequence of Poses 126 may be referred to as an Animation 127 and may contain a function a (t): Z, R→A which maps each Pose 126 i to a given time t. For any given value of t the function a returns a Pose that is the result of the interpolation or extrapolation along the time-domain, of the Poses 126 contained in the Animation 127.

A Motion Generator 125 may be any electronic computer system which may be given a set of parameter inputs, which may or may not include a time-parameter t, and that may output Poses 126, Animations 127 or Motion Parameters 103.

The playback of a Motion Source 105 is a process that may cause a modification to the values of the Motion Parameters 103 of some or all of the Motion Channels 124 of the Motion Source 105, based on provided Motion Target Parameters 122 and optionally on an internally or externally-driven time-step value.

### Animation Planning

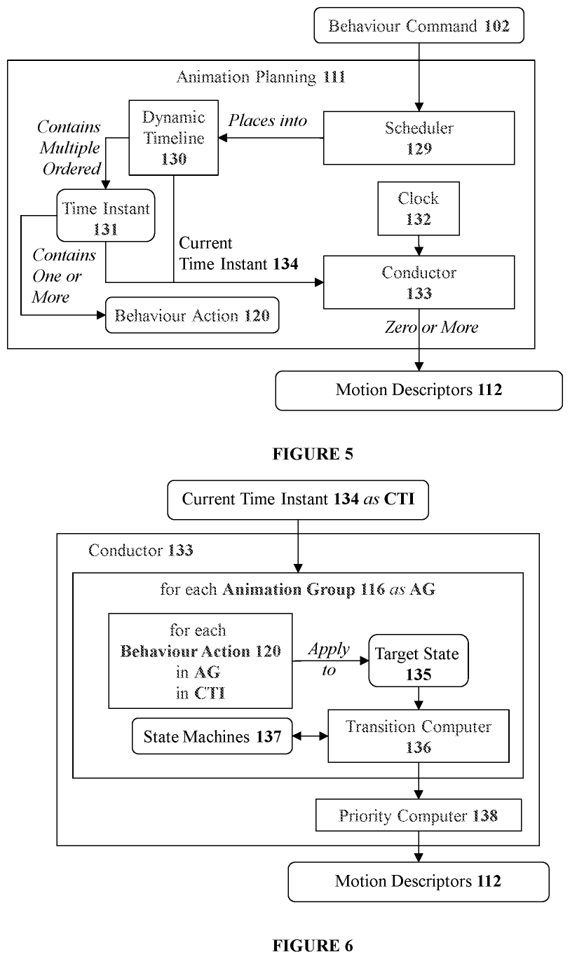

FIG. 5 shows a schematic representation of an Animation Planning 111 system. The Animation Planning 111 stage may consist of a Scheduler 129 step and a Conductor 133 step which may contain a system of multi-channel state machines that are triggered to change the state of each channel based on its internal state and/or on an input Behaviour Command 102. Each channel of the Conductor 133 may correspond to a Motion Target 115. The internal state of the Animation Planning 111 may be driven by an internal Clock 132 without an external trigger. The trigger of execution of the Animation Planning 111 system by means of an internal Clock 132 is referred to as a Time-Step.

The Animation Planning 111 system serves as a controller for the Animation Mixing 113 system. It translates the input Behaviour Commands 102 into an incremental Dynamic Timeline 130. The Dynamic Timeline 130 is used to cause changes to the channel states within the Conductor 133, from which streams of multiple Motion Descriptors 112 may be continuously output.

Within the Conductor 133 a Motion Target 115 may be in various states such as, but not limited to Active, Inactive, Fading-In (non-instantaneous transition from inactive to active) or Fading-Out (non-instantaneous transition from active to inactive).

A Motion Target 115 may belong to an Animation Group 116. The concept of Animation Group 116 may be absent, in which case all systems work as if there were a single default Animation Group 116, to which all Motion Targets 115 belong, without explicitly referring to it.

FIG. 6 shows the Conductor 133 system within the Animation Planning 111 system. The role of the Conductor 133 may be to collect a new Target State 135 based on the set of Behaviour Actions 120 that exist in the Dynamic Timeline 130 at each moment of time (Time Instant 131), the current one being referred to as Current Time Instant 134, and provide it to a Transition Computer 136.

A Transition Computer 136 may contain a state machine for each Motion Target 115 and may contain transition logic to detect and respond to state changes. An example of such logic would be that given a new Target State 135, the state of each Motion Target 115 within the new Target State 135, that is not current Active or Blending-In within the State Machines 137, is switched to Blending-In, while the state of each Motion Target 115 within the current State Machines 137 that are currently Active or Blending-in but not contained in the new Target State 135 is switched to Blending-Out.

Each state of the Transition Computer 136 may additionally contain electronic computer systems that are executed on every Time-Step and may operate over each channel that is currently in that state. An example of that would be that in a Blending-Out state, a signal processing computer would progressively drive the value of each channel to zero on each Time-Step until it reaches a near-zero value. Additional example transition logic may exist in the Transition Computer 136 such as to detect when the Blending-Out processing has completed for any channel, and automatically switch that channel to an Inactive state.

A Priority Computer 138 may partially or totally inhibit the output value, or cause a change to the state, of lower priority channels, based on the value and, or, the state of higher priority channels.

### Animation Mixing

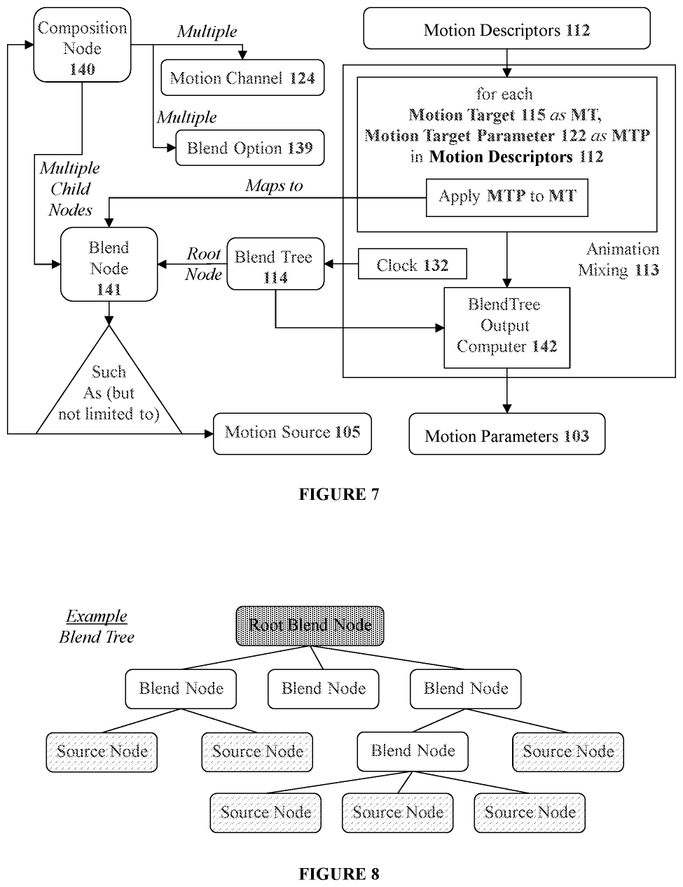

FIG. 7 shows the Animation Mixing 113 system. The Animation Mixing 113 stage may consist of applying each Motion Target Parameters 122 to the corresponding Blend Nodes 141 of the Blend Tree 114, and then computing the resulting output of the Blend Tree 114.

FIG. 8 shows an example Blend Tree 114. The computation of the output of the Blend Tree 114 is performed by a BlendTree Output Computer 142 and may follow an algorithm for traversing tree structures such as, but not limited to a depth-first search, which visits each node and expands it in case it is a Composition Node 140, or performs the playback of one Time-Step in case it is a Source Node, or may follow any other algorithm, technique or electronic computer program that produces a similar result.

The output of a Composition Node 140 is the result of performing a composition operation across its child Blend Nodes 141. The composition operation may be defined based on multiple Blend Options 139. The output of a Blend Node may act as, and, or, be used as, a Motion Source.

The composition of Blend Nodes 141 is an operation that takes as input a set of child Blend Nodes 141 and may take as input a set of Blend Options 139 that configure the operation, and outputs a Motion Source 105 whose codomain may correspond to a composition of the codomains of each child's Motion Source 105 as the result of an operation applied across the space of Motion Parameters 103 of each Motion Source 105. One such example composition operation may be Additive Blending in which the output of the Composition Node 140, as a Motion Source 105, may correspond to the sum of the values of its child Blend Nodes' 141 Motion Sources 105.

Space-warping is a process that takes as input a Motion Source 105 and may take as input a set of parameters that configure the process and outputs a Motion Source 105 that may be the result of altering the codomain of the input Motion Source 105.

Time-warping is a process that takes as input an Animation and may take as input a set of parameters that configure the process, and outputs an Animation 127 that may be the result of altering the time-domain of the input Animation 127 and may be the result of altering the mapping function a and may be the result of altering the codomain of the input Animation 127.

A Blend Node 141 may perform Space-warping and, or Time-warping whenever it is computed by the BlendTree Output Computer 142, based on parameters provided to the Blend Node 141 as Motion Descriptors 112.

### Interpretation

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and user requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method for controlling motion of a digital character, comprising:
i. receiving one or more behaviour commands;
ii. translating the one or more behaviour commands into a time sequence of channel parameters for one or more animation channels;
iii. receiving one or more motion sources;
iv. determining one or more motion parameters by applying the time sequence of channel parameters to corresponding blend nodes in a blend tree based on the motion sources; and
v. controlling motion of the digital character based on the one or more motion parameters.

2. The method of claim 1, wherein the one or more behaviour commands describe and specify behaviour actions along with supplementary motion and composition configurations.

3. The method of claim 1 or claim 2, wherein the one or more behaviour commands comprise behaviour metadata and a command descriptor.

4. The method of any one of claims 1 to 3, wherein receiving motion sources comprises receiving a pose of the digital character that is interpolated or extrapolated in the time-domain.

5. The method of any one of claims 1 to 4, wherein receiving motion sources comprises receiving a pose of the digital character that is neither interpolated or extrapolated.

6. The method of any one of claims 1 to 5, wherein the motion sources comprise a high priority motion source and a low priority motion source, wherein the high priority motion source superimposes over a low priority motion source in determining one or more motion parameters.

7. The method of any one of claims 1 to 5, wherein the motion sources comprise a plurality of motion sources, each motion source having a priority, wherein the plurality a plurality of motion sources are order by their priority and a high priority motion source superimposes over a low priority motion source in determining one or more motion parameters.

8. The method of any one of claims 1 to 7, wherein the time sequence of channel parameters is based on incremental time steps.

9. The method of any one of claims 1 to 8, wherein the time sequence of channel parameters is configured to cause changes to channel states in an animation planner.

10. The method of any one of claims 1 to 9, further comprising computing an output of the blend tree.

11. The method of claim 10, wherein computing the output of the blend tree follows an algorithm for traversing tree or graph data structures.

12. The method of claim 10, wherein computing the output of the blend tree follows a method that produces a similar result as a depth-first search.

13. The method of any one of claims 1 to 12, wherein the blend tree comprises a single root blend node, a plurality of blend nodes adjacent to the root blend node or to the plurality of blend nodes, and a plurality of source nodes adjacent to the plurality of blend nodes.

14. The method of any one of claims 1 to 13, wherein determining one or more motion parameters comprises performing space-warping.

15. The method of any one of claims 1 to 14, wherein determining one or more motion parameters comprises performing time-warping.

16. A non-transitory computer-readable medium comprising instructions which, when executed by a computer, cause the computer to perform the method of claim 1.

17. A system for controlling motion of a digital character according to the method of claim 1, comprising:
i. a behaviour command system for selecting and providing behaviour commands;
ii. an animation framework for receiving and processing behaviour commands and motion sources;
iii. animation channels configurable based on channel parameters;
iv. a controller for controlling motion of the digital character based on motion parameters; and
v. a presentation system for presenting the controlled motion of the digital character.

18. The system of claim 17, wherein the animation framework comprises an animation planning system comprising multi-channel state machines and a clock, wherein states of the multi-channel state machines are configured to change at a time-step generated by the clock.

19. The system of claim 18, further comprising a conductor system configured for determining a target state based on behaviour commands and for adjusting an animation channel of the multi-channel state machines based on the target state.

20. The system of any one of claims 17 to 19, wherein the animation framework comprises an animation mixing system, the animation mixing system being configured to apply channel parameters to corresponding blend nodes of a blend tree.
